(19) United States
(12) Patent Application Publication
(10) Pub. No.: US 2014/0223660 A1
(43) Pub. Date: Aug. 14, 2014

(54) PATIENT LIFT DEVICE

(71) Applicant: HANDICARE AB, Jarfalla (SE)

(72) Inventor: Andreas Bolin, Gammelstad (SE)

(73) Assignee: HANDICARE AB, Jarfalla (SE)

(21) Appl. No.: 13/841,460

(22) Filed: Mar. 15, 2013

Related U.S. Application Data
(60) Provisional application No. 61/763,256, filed on Feb. 11, 2013.

(51) Int. Cl. A61G 7/10

(52) U.S. Cl. CPC A61G 7/10
USPC 5/83.1

(57) ABSTRACT

A person lift device for safe transfer of bariatric persons includes a movable trolley, a support being rotatably suspended from the trolley and two motor devices for lifting and lowering of person, wherein the motor devices are coupled to the support.

### FIELD OF THE INVENTION

The present invention generally relates to the field of devices for lifting and transfer of persons. In particular, the present invention relates to devices for lifting and transfer of bariatric patients.

### BACKGROUND OF THE INVENTION

Conventional person lift devices normally comprise one motor coupled to a trolley adapted to ride in a rail of a person lift system. However, for lifting bariatric patients, two motors are required to provide sufficient lifting capacity. A drawback with known two motor person lift devices which are able to rotate the person, i.e. bariatric lifting devices, is that such systems require two parallel rails for distributing load and moments of force from uneven load on the motor devices. As a result, such two-rail systems may only provide a straight travel path because of the inherent difficulties of simultaneous movement or driving of parallel motors along curved rails.

### SUMMARY OF THE INVENTION

An object of the present invention is to provide an improved and more efficient person lift device for bariatric persons and a transfer system comprising such a person lift device.

This and other objects are achieved according to the present invention by providing a person lift device and a transfer system having the features defined in the independent claims. Embodiments of the invention are defined in the dependent claims.

According to a first aspect of the present invention, there is provided a person lift device for safe transfer of bariatric persons comprising:

A movable trolley;

a support being rotably suspended from to the trolley; and

two motor devices for lifting and lowering of person, wherein the motor devices are coupled to the support.

In other words, the support is vertically and horizontally rotatable relative the trolley, Put differently, the support may be rotatable around a vertical axis and also tiltable back and forth in its lengthwise direction. The support may be rotatable or tiltable around both a horizontal rotational axis and a vertical rotational axis. The horizontal rotational axis may be described as lying in the horizontal plane, i.e. a plane which is parallel with the overhead or suspended rail. Consequently, when the support is parallel or longitudinally aligned with the rail, the horizontal rotational axis extends transverse to the rail. The horizontal plane may also be described as being perpendicular to the plumb line (assuming that the overhead or suspended rail is in level). It is also understood that the vertical rotational axis extends perpendicularly to the rail and essentially along the plumb line (assuming that the rail is in level).

The movable trolley may be adapted to be movable in a monorail or monorail system. The monorail may for example be suspended from or attached to a ceiling or an overhead arrangement. Alternatively, the monorail may be part of a freestanding rail system, i.e. a rail held in an elevated position by legs standing on the floor. It is understood that monorail refers to a single rail or track in or on which the trolley is movably arranged. The monorail system may comprise a plurality of consecutively coupled monorail portions, for example a straight rail portion followed by a curved rail portion.

According to a second aspect of the present invention, there is provided a transfer system comprising a monorail system and a person lift device according to the first aspect of the invention. The trolley of the person lift device is movably arranged in or on a rail of the monorail system.

The invention is based on the insight that by providing two motor devices arranged on a support connected to a common trolley in the rail system, an easily maneuverable person lift device for bariatric patients able to travel along a single rail is achieved. Especially, such a person lift device enables a curved movement thereof along a curved single rail. As the present device comprises a single trolley, it allows travelling along a single and curved rail. As the support is rotatably suspended from the trolley, the support can rotate or tilt around a horizontal rotational axis such that any uneven load on the lift device results in a slight inclination of the support, thereby reducing the moments of force transferred (or applied to) the rail, thereby resulting in a comfortable and safe transfer of a bariatric person along a rail system suspended in a room.

According to example embodiments of the first or second aspect of the invention:

the support may be provided with two opposite end portions rotatably coupled to the trolley.

the system may further comprise a first rod and a second rod coupled between the end portions of the support and the trolley.

the first and second rods may be adapted to be rotatably coupled to the trolley.

the trolley may comprise three sub trolleys hinged or connected to each other in series for enabling cornering of the trolley when riding in a curved rail.

the first and second rods may be coupled to an intermediate sub trolley arranged between two end sub trolleys.

the motor devices may be arranged at a distance from each other.

the motor devices may be arranged at a distance from each other at a distance within an interval of 1.5 m to 0.4 m, preferably within an interval of 1 m to 0.5, such as around 0.65 m.

the motor devices may be arranged at a distance from each other corresponding to the size of a bariatric patient in order to obtain a comfortable transfer and/or lifting. In particular, the motor devices may be arranged at a distance from each other corresponding to the horizontal projection of a bariatric patients torso when seated in a partially reclined position.

at least one of the motor devices may be movably coupled to the support. In other words, at least one of the motor devices may be coupled to the support such that it is movable along the support, i.e. in the long direction of the support. Thereby, the position of the at least one of the motor devices may be adjusted to compensate for unbalanced load.

the support may be at least 0.5 m and preferably at least 0.75 m long in order to enable sufficient space between the motor devices.

the support may be rotatably coupled to the trolley by a swivel coupling.

the first and second rods may be arranged such that the lengths of the first and second rods and the positions of their connection points to the support is adapted to be able to hold the support in a substantially horizontal position with a maximum horizontal deviation of 15, preferably 10, and even more preferably 7 degrees.

the first and second rods may have the same length and may be mounted symmetrically to the support.

the total lifting capacity of the two motor devices may be at least 300 kg, preferably at least 450 kg, and even more preferably at least 600 kg.

the support is a bar.

the support comprises a bar, wherein two motor devices are coupled to the bar.

at least one of the motor devices is movably coupled to the bar and/or the support. The motor devices may thereby be adjusted along the support or bar to adjust the inclination thereof in order to compensate any unbalance of the support or bar.

at least one of the motor devices is releasably connected to the bar and/or support. The motor devices may thereby be adjusted along the support or bar to adjust the inclination thereof in order to compensate any unbalance of the support or bar.

at least one of the motor devices is fixedly arranged along the bar and/or support, for example the motor devices may be fixedly arranged at opposite ends of the bar.

### BRIEF DESCRIPTION OF THE DRAWINGS

FIG. 1a shows a person lift device 1 installed in a rail 6.

FIG. 1b shows a person lift device 1 installed in a rail 6 with a bariatric patient seated in a sling coupled to the motor devices of the device.

FIG. 2 shows a person lift device (without motor devices) in a non-assembled state.

FIG. 3 shows mounting of the second rod 7 to the support or bar 2.

FIG. 4 shows mounting of the first and second rods 4, 7 to the trolley.

FIG. 5 shows an assembled person lift device (without motor devices).

FIG. 6 shows the assembled person lift device (without motor devices) installed in the rail.

FIG. 7 shows the assembled person lift device installed in the rail with one of the two motor devices mounted to the support or bar.

FIG. 8 is an enlarged view of the motor device attachment of the arrangement shown in FIG. 7.

FIG. 9 shows the completely assembled person lift device (i.e. with both motor devices mounted to the support or bar) installed in the rail.

FIG. 10 shows the person lift device with even load distribution, wherein the support or bar is (at least almost) horizontal.

FIG. 11 shows the person lift device with uneven load distribution wherein the support or bar is slightly inclined and deviates from a horizontal reference line.

### REFERENCE NUMBERS IN THE FIGURES INDICATE

1 Patient lift device
2 Support, e.g. a bar (or a beam)
3 end portions of the support or bar
4 first rod (or interconnecting element)
5 trolley
6 rail of monorail system
7 second rod (or interconnecting element)
8 a-b motor devices
9 imaginary horizontal rotational axis
10 a-c three hingedly connected sub trolleys
11 link arrangement
12 swivel coupling
13 lifting sling with slingbar
14 patient
15 imaginary vertical rotational axis
16 fork device
17 mounting bracket

### DETAILED DESCRIPTION OF EMBODIMENTS

In the following, an illustrative non-limiting example according to an embodiment will be described with reference to the appended drawings.

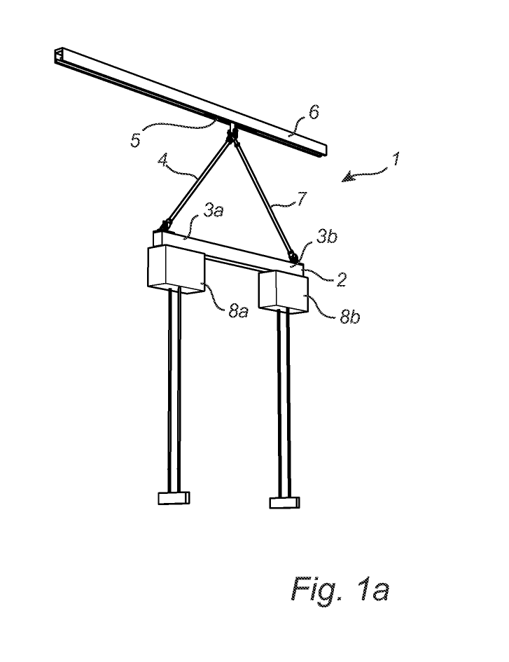

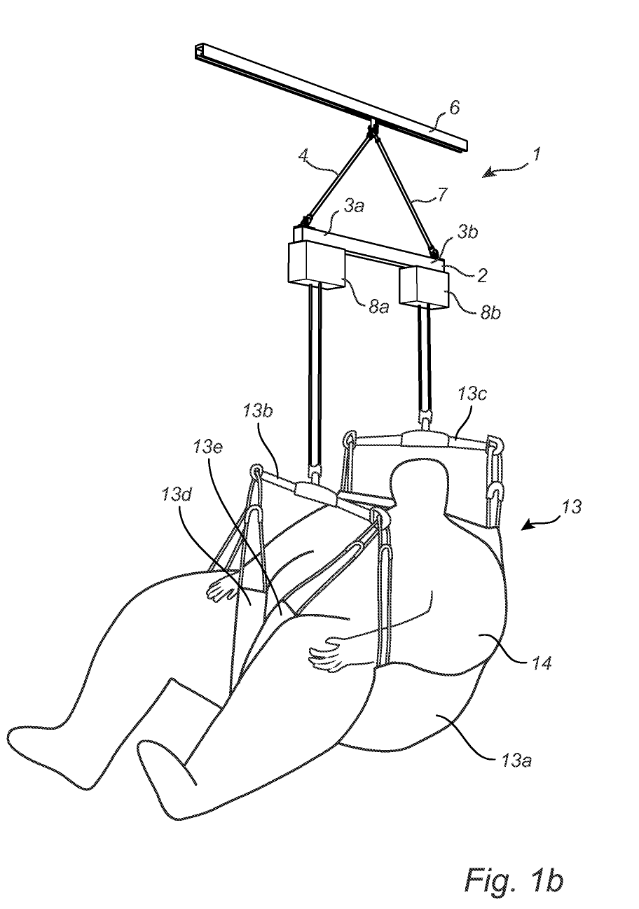

FIG. 1a shows the transfer system, i.e. a person lift device suspended from a rail 6. The system comprises a lifting support or lifting bar 2 which does not absorb moments of force (i.e. a hinged support or bar) suspended from a reinforced trolley 5 adapted for straight and curved rails. Two motor devices 8a, 8b are attached to the lifting support or lifting bar 2. The system is adapted for bariatric patients (>250 kg) and with the possibility to rotate the lifting support or lifting bar 2.

The basic system consists of:
1. A reinforced steel bar 2
2. A standard H64 rail 6
3. Dual threaded rods 4, 7 of equal length (the length is adapted to different heights of installation) with bolt connections.
4. A 3-hinged trolley 5 with a swiveling coupling which is adapted for curved rails.
5. Two RiseAtlas450 person lift motors 8a, 8b with a total lifting force of 2×205 kg=410 kg.
   For example, the rail height may be approximately 2360 mm (in a Wilkes Barres installation) or 2734 mm (in a Danville installation).

Prototypes according to Wilkes Barre have a building height of approximately 400 mm to achieve a motor height of the RiseAtlas of approximately 1800 mm. The two RiseAtlas motors 8a, 8b are arranged at a fixed distance 650 mm apart.

The load on the two RiseAtlas450 motors can be distributed 50-50%, i.e. 135 kg per RiseAtlas and the maximum deviation in load distribution may be 55-45%, e.g. 148 kg-122 kg at max load 270 kg.

Lifting and lowering of load should only occur when the support or lifting bar 2 is arranged along (i.e. longitudinally aligned with) the upper trolley rail 6.

FIG. 1b shows the same transfer system as in FIG. 1a where a bariatric patient 14 is seated in a lifting sling 13. The lifting sling comprises a sling 13a and two sling bars 13b, 13c. Rear and front edges of the seat are coupled to the rear and front sling bars 13b, 13c, respectively, via straps. Two leg support portions 13d, 13e extend up between the legs of the patient and are coupled to the front sling bar 13b via straps. The sling bars are coupled to the belts of the motor devices 8a, 8b at centre positions thereof such that the patient may be raised and lifted when seated in the sling. The patient 14 is seated in a partially reclined position and the distance between the motor devices 8a, 8b has been adjusted to correspond to the length of the horizontal projection of the patients' torso.

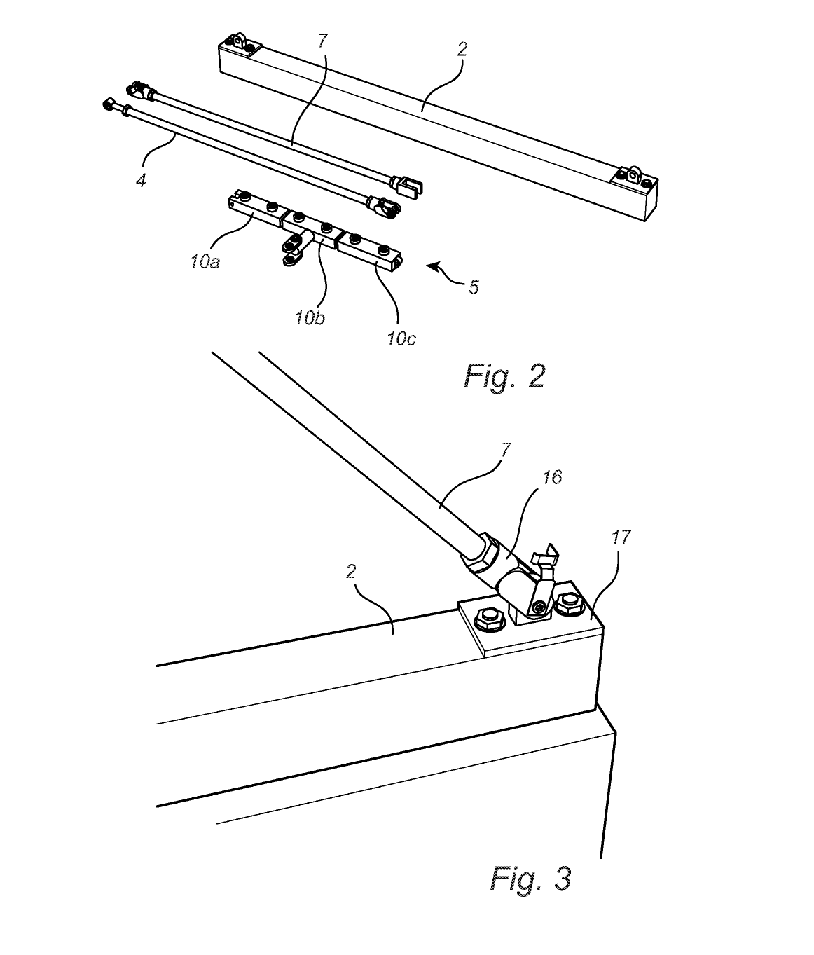

FIG. 2 shows a person lift device (without motor devices) in a non-assembled state. The person lift device comprises a support or bar 2, first and second rods 4, 7 and a trolley 5 comprising three hingedly connected sub trolleys 10a-10c. The intermediate sub trolley 10b comprises means 11, 12 for coupling the rods thereto.

FIG. 3 shows mounting of the second rod 7 to the support or bar 2. A first end of the second rod is connected to a fork device 16 by means of threads. The fork device is rotatably coupled to the support or the bar 2 via a bolt through a bracket 17 which is attached to an end portion of the support or bar 2.

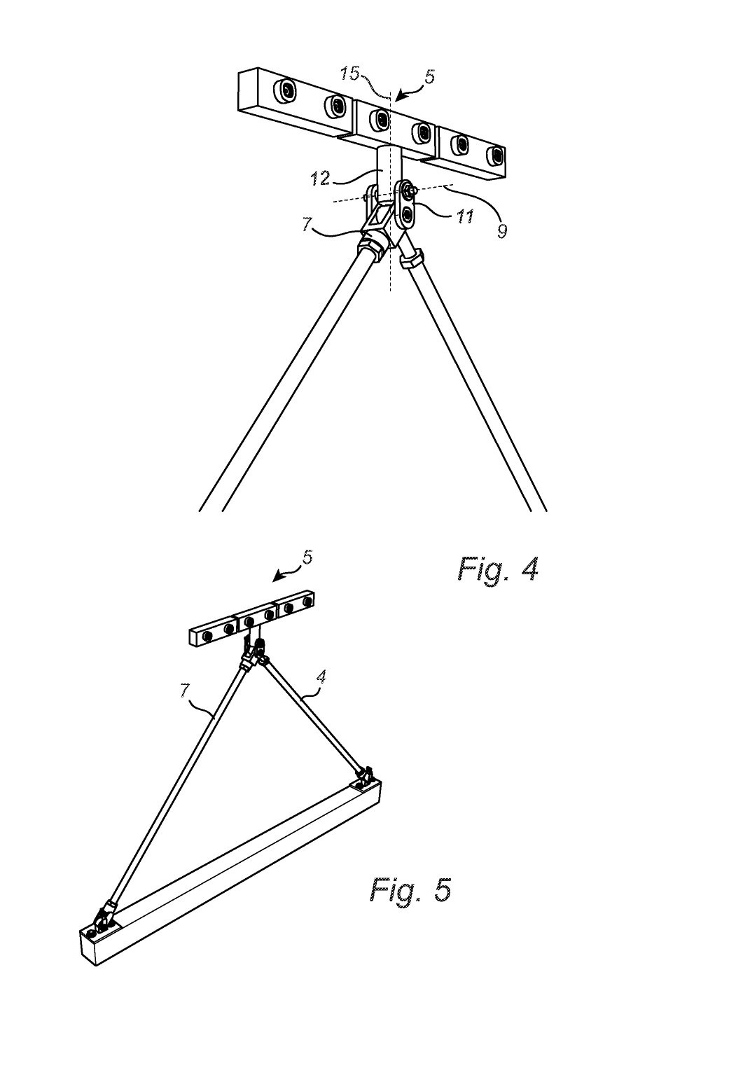

FIG. 4 shows mounting of the first and second rods 4, 7 to the trolley via a link arrangement 11 making the first and second rods rotatable with respect to the trolley around a horizontal rotational axis (lying in the horizontal plane). The link arrangement 11 is coupled to the trolley 5 by means of a swivel coupling 12 making the link and the first and second rods rotatably coupled to the trolley around a vertical rotational axis 15.

The person lift device may be assembled by:

1. Assembling the dual threaded rods 4, 7 to the reinforced steel bar 2 (by securing the axle bolts properly, such that they are properly locked), see FIGS. 3, and

2. Assembling the dual threaded rods 4, 7 to centre link arrangement 11 coupled to trolley 5 (secure that axle bolt or screw has been threaded), see FIG. 4.

FIG. 5 shows the structure or design after these two steps.

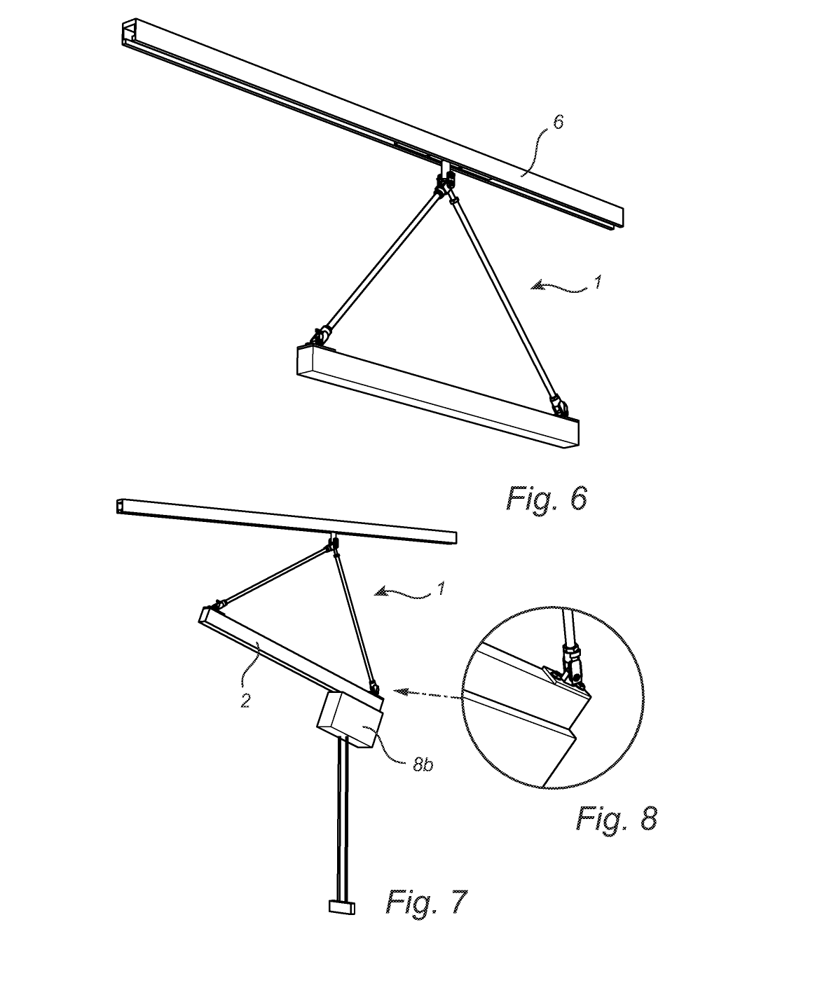

FIG. 6 shows the assembled person lift device (without motor devices) installed in the rail. The person lift device may be installed by lifting the entire design/structure up to rail and inserting the trolley into the rail, see FIG. 6

FIG. 7 shows the assembled person lift device 1 installed in the rail with one of the two motor devices 8b mounted to the support or bar 2. FIG. 8 is an enlarged view of the motor device attachment of the arrangement shown in FIG. 7. The motor is installed by loosening an outer screw of the H64 rail and inserting the RiseAtlas motor. The result is a strong inclination with only one motor. The motor is locked in place with the outer screw.

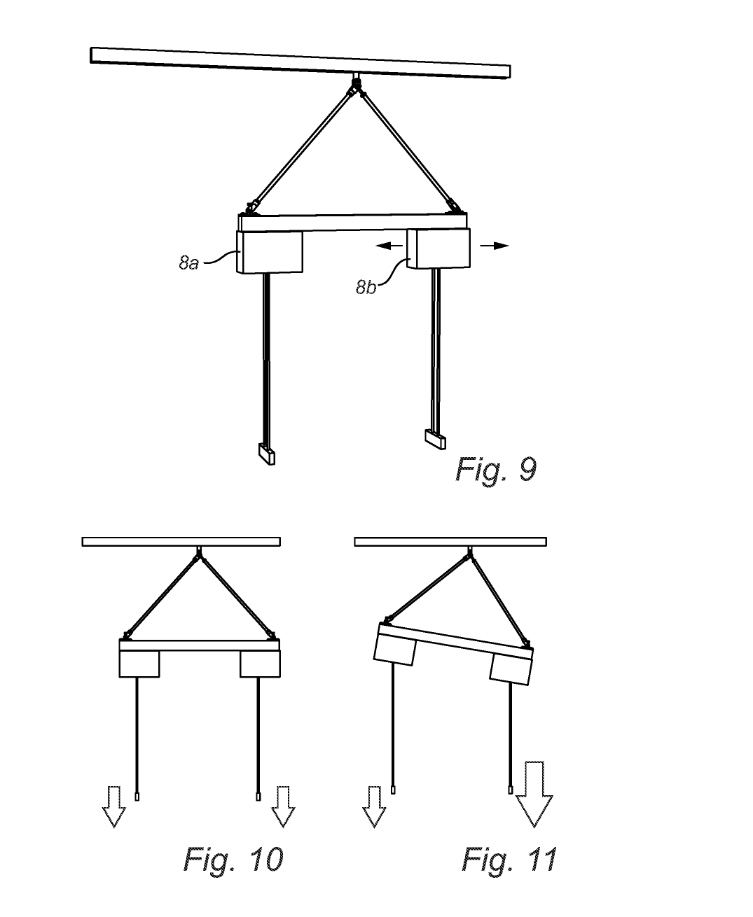

FIG. 9 shows the situation when both motors 8a, 8b are in position and the device is in balance.

At an even load distribution (50%-50%), the structure/design will be well-balanced, see FIG. 10. The position of the lift motors devices 8a, 8b may be adjusted to achieve balance, i.e. the motors devices 8a, 8b are movably arranged in or coupled to the bar or the support 2. However, as mentioned above, at least one of the motor devices may be releasably connected to the bar and/or support. In yet another alternative, the other or both motor devices may be fixedly arranged along the bar and/or support, e.g. the motor devices are fixedly arranged at opposite ends of the bar.

At an uneven load distribution (max 55-45%) will result in an inclination of about 7 degrees, which should not be exceeded, see FIG. 11.

While specific embodiments have been described, the skilled person will understand that various modifications and alterations are conceivable within the scope as defined in the appended claims.

### LIST OF EMBODIMENTS

E1. A transfer system for safe transfer of bariatric persons (1) comprising:

A suspended rail (6) and a trolley (5) being movable therein;

a bar (2) being rotably coupled to the trolley (5); and

two motor devices (8a, 8b) for lifting and lowering of person, wherein the motor devices are attached to the bar.

E2. The transfer system according to embodiment 1, wherein the bar is provided with two opposite end portions (3a, 3b) rotatably coupled to the trolley.
E3. The transfer system according to embodiment 1, wherein the system further comprises a first rod (4) and a second rod (7) coupled between the end portions of the bar and the trolley.
E4. The transfer system according to embodiment 3, wherein the first and second rods are adapted to be rotatably arranged to the trolley.
E5. The transfer system according to any one of the preceding embodiments, wherein the trolley comprises three sub trolleys (10a-c) hinged or connected to each other in series for enabling cornering of the trolley when riding in a curved rail.
E6. The transfer system according to any one of the preceding embodiments, wherein the first and second rods are coupled to an end sub trolley having an intermediate sub trolley there between.
E7. The transfer system according to any one of the preceding embodiments, wherein the motor devices are arranged at a distance from each other
E8. The transfer system according to any one of the preceding embodiments, wherein the motor devices are arranged at a distance from each other at a distance within an interval of 1.5 m to 0.4 m, preferably within an interval of 1 m to 0.5, such as around 0.65 m.
E9. The transfer system according to any one of the preceding embodiments, wherein the motor devices are arranged at a distance from each other corresponding to the width of a bariatric patient in order to obtain a comfortable transfer and/or lifting.
E10. The transfer system according to any one of the preceding embodiments, wherein at least one of the motor devices is movably arranged along the bar.
E11. The transfer system according to any one of the preceding embodiments, wherein at least one of the motor devices is fixedly arranged along the bar.
E12. The transfer system according to any one of the preceding embodiments, wherein the motor devices are fixedly arranged at either end of the bar.
E13. The transfer system according to any one of the preceding embodiments, wherein the bar is at least 0.5 m and preferably at least 0.75 m long in order to enable sufficient space between the motor devices.
E14. The transfer system according to any one of the preceding embodiments, wherein bar is rotatably coupled to the trolley by a swivel coupling
E15. The transfer system according to any one of the preceding embodiments, wherein the first and second rods are arranged such as the lengths of the first and second rods and the positions of their connection points to the bar is adapted to be able to hold the bar in a substantially horizontal position with a maximum horizontal deviation of 15, preferably 10, and even more preferably 7 degrees.
E16. The transfer system according to any one of the preceding embodiments, wherein the first and second rods have the same length and are mounted symmetrically to the bar.
E17. The transfer system according to any one of the preceding embodiments, wherein the total lifting capacity of the two motor devices is at least 300 kg, preferably at least 450 kg, and even more preferably at least 600 kg.

1. A person lift device for safe transfer of bariatric persons comprising:
a trolley;
a support being rotatably suspended from the trolley; and
two motor devices for lifting and lowering of person, wherein the motor devices are coupled to the support.

2. The person lift device according to claim 1, wherein the support is provided with two opposite end portions rotatably coupled to the trolley.

3. The person lift device according to claim 1, wherein the system further comprises a first rod and a second rod coupled between the respective end portions of the support and the trolley.

4. The person lift device according to claim 3, wherein the first and second rods are adapted to be rotatably coupled to the trolley.

5. The person lift device according to claim 1, wherein the trolley comprises three sub trolleys hinged or connected to each other in series for enabling cornering of the trolley when riding in a curved rail.

6. The person lift device according to claim 1, wherein the first and second rods are coupled to an intermediate sub trolley arranged between two end sub trolleys.

7. The person lift device according to claim 1, wherein the motor devices are arranged at a distance from each other.

8. The person lift device according to claim 1, wherein the motor devices are arranged at a distance from each other at a distance within an interval of 1.5 m to 0.4 m, preferably within an interval of 1 m to 0.5, such as around 0.65 m.

9. The person lift device according to claim 1, wherein the motor devices are arranged at a distance from each other corresponding to the size of a bariatric patient in order to obtain a comfortable transfer and/or lifting.

10. The person lift device according to claim 1, wherein the support is at least 0.5 m and preferably at least 0.75 m long in order to enable sufficient space between the motor devices.

11. The person lift device according to claim 1, wherein the support is rotatably coupled to the trolley by a swivel coupling.

12. The person lift device according to claim 1, wherein the first and second rods are arranged such that the lengths of the first and second rods and the positions of their connection points to the support is adapted to be able to hold the support in a substantially horizontal position with a maximum horizontal deviation of 15, preferably 10, and even more preferably 7 degrees.

13. The person lift device according to claim 1, wherein the first and second rods have the same length and are mounted symmetrically to the support.

14. The person lift device according to claim 1, wherein the total lifting capacity of the two motor devices is at least 300 kg, preferably at least 450 kg, and even more preferably at least 600 kg.

15. The person lift device according to claim 1, wherein the support is rotatable or tiltable relative the trolley around a horizontal rotational axis and around a vertical rotational axis.

16. The person lift device according to claim 1, wherein the support is a bar.

17. The person lift device according to claim 1, wherein the support comprises a bar, wherein two motor devices are coupled to the bar.

18. The person lift device according to claim 1, wherein at least one of the motor devices is movably coupled to the bar and/or the support.

19. The person lift device according to claim 1, wherein at least one of the motor devices is releasably connected to the bar and/or support.

20. The person lift device according to claim 1, wherein at least one of the motor devices is fixedly arranged along the bar and/or support.

21. The person lift device according to claim 20, wherein the motor devices are fixedly arranged at opposite ends of the bar or support.

22. A transfer system comprising a monorail system and a person lift device according to claim 1, said trolley of said person lift device being movably arranged in a rail of said monorail system.
